(19) United States
(12) Patent Application Publication
(10) Pub. No.: US 2012/0070621 A1
(43) Pub. Date: Mar. 22, 2012

(54) CONDUCTIVE FILM FORMING METHOD, CONDUCTIVE FILM FORMING APPARATUS AND CONDUCTIVE FILM

(75) Inventor: Tohru Nukui, Tokyo (JP)

(73) Assignee: TOKYO ELECTRON LIMITED, Tokyo (JP)

(21) Appl. No.: 13/321,663

(22) PCT Filed: May 6, 2010
(86) PCT No.: PCT/JP2010/003104

§ 371 Date: Nov. 21, 2011

(30) Foreign Application Priority Data
May 22, 2009 (JP) 2009-124182

(51) Int. Cl. B32B 3/30; C08F 2/48; B32B 5/02; B05D 5/12; B82Y 30/00

(52) U.S. Cl. 428/156; 427/58; 427/508; 118/642; 977/832

(57) ABSTRACT

There is provided a conductive film forming method including disposing a material 2 containing a fiber-shaped conductive substance 2a and having fluidity between a substrate 3 and a mold 1 having thereon prominences and depressions 1a; reducing the fluidity of the material 2; and separating the mold 1 from the material 2.

### TECHNICAL FIELD

The present disclosure relates to a conductive film forming method and a conductive film forming apparatus, and also relates to a conductive film.

### BACKGROUND ART

Conventionally, as a conductive film for use in a transparent electrode of a transparent substrate, an ITO (Indium Tin Oxide) film has been widely used. Further, there has been known that the transparent electrode is formed by dispersing carbon nanotubes as fiber-shaped conductive substances (see, for example, Patent Document 1).

Further, there has been proposed a conductive film forming method that coats a transparent electrode with a mixture of carbon nanotubes as fiber-shaped conductive substances and particulate materials, and then, removes the particulate materials to form a thin film containing carbon nanotubes in a mesh shape (see, for example, Patent Document 2). That is, in this method, by providing the particulate materials, it is possible to form the mesh-shaped thin film in which the carbon nanotubes are appropriately dispersed.

Further, there has been also known a nanoimprint lithography in which a mold (pattern) having a fine three-dimensional structure is formed by a LIGA process or a FIB (Focused Ion Beam) process, and a pattern on the mold is transferred to a resist film coated on a substrate by pressing the mold onto the resist film (see, for example, Patent Document 3). This nanoimprint lithography has been used to transfer the pattern to the resist film, instead of a conventional photolithography technique that performs an exposure and development process. The nanoimprint lithography may be applied to the manufacture of, e.g., an information recording device. This technique, however, has not been performed to form the transparent electrode including fiber-shaped conductive substances such as carbon nanotubes.

Patent Document 1: Japanese Patent Laid-open Publication No. 2007-169120

Patent Document 2: Japanese Patent Laid-open Publication No. 2008-177165

Patent Document 3: Japanese Patent Laid-open Publication No. 2005-108351

### DISCLOSURE OF THE INVENTION

### Problems to be Solved by the Invention

In the conductive film forming technique of forming the thin film containing carbon nanotubes in a mesh shape by using the particulate materials, since the fine particulate materials are used, the processes for mixing the particulate materials and removing the mixed particulate materials are additionally required. Thus, time and cost for forming the conductive film is increased, resulting in poor productivity.

In view of the foregoing problems, the present disclosure provides a conductive film forming method, a conductive film forming apparatus and a conductive film, capable of improving productivity by reducing time and cost for forming the conductive film as compared to conventional cases.

### Means for Solving the Problems

In accordance with one aspect of the present disclosure, there is provided a conductive film forming method. The method includes disposing a material containing a fiber-shaped conductive substance and having fluidity between a substrate and a mold having thereon prominences and depressions; reducing the fluidity of the material; and separating the mold from the material.

In accordance with another aspect of the present disclosure, there is provided a conductive film forming method. The method includes coating a material containing a fiber-shaped conductive substance and having fluidity on a mold having thereon prominences and depressions; bringing a substrate into contact with the material coated on the mold to dispose the material between the substrate and the mold; reducing the fluidity of the material; and separating the mold from the material.

In accordance with still another aspect of the present disclosure, there is provided a conductive film forming method. The method includes coating a material containing a fiber-shaped conductive substance and having fluidity on a substrate; providing the material between the substrate and a mold having thereon prominences and depressions by bringing the mold into contact with the material coated on the substrate; reducing the fluidity of the material; and separating the mold from the material.

In accordance with still another aspect of the present disclosure, there is provided a conductive film forming method. The method includes placing a mold having thereon prominences and depressions to be adjacent to a substrate while allowing the prominences and depressions to face the substrate; providing a material containing a fiber-shaped conductive substance and having fluidity between the substrate and the mold by supplying the material into a space between the mold and substrate; reducing the fluidity of the material; and separating the mold from the material.

In accordance with still another aspect of the present disclosure, there is provided a conductive film forming apparatus for forming a conductive film on a substrate. The conductive film forming apparatus includes a vessel that stores therein a material containing a fiber-shaped conductive substance and having fluidity, and that includes a device for mixing the material; a mold having thereon prominences and depressions; a nozzle, communicating with the vessel, for coating the material on either the mold or the substrate; a device for placing the substrate to be adjacent to the mold; and a hardening unit for reducing the fluidity of the material between the mold and the substrate.

In accordance with still another aspect of the present disclosure, there is provided a conductive film including a fiber-shaped conductive substance; and a layer having prominences and depressions on a top surface thereof.

### EFFECT OF THE INVENTION

In accordance with the present disclosure, it is possible to provide a conductive film forming method, a conductive film forming apparatus and a conductive film, capable of improving productivity by reducing time and cost for forming the conductive film as compared to conventional cases.

### BRIEF DESCRIPTION OF THE DRAWINGS

FIG. 1 is a diagram for describing a process sequence of a conductive film forming method in accordance with a first embodiment of the present disclosure.

FIG. 2 is a diagram for describing a process sequence of a conductive film forming method in accordance with a second embodiment of the present disclosure.

FIG. 3 is a diagram for describing a process sequence of a conductive film forming method in accordance with a third embodiment of the present disclosure.

FIG. 4 is a diagram for describing a configuration of a conductive film forming apparatus in accordance with the first embodiment of the present disclosure.

FIG. 5 is a diagram for describing a configuration of a conductive film forming apparatus in accordance with the second embodiment of the present disclosure.

### BEST MODE FOR CARRYING OUT THE INVENTION

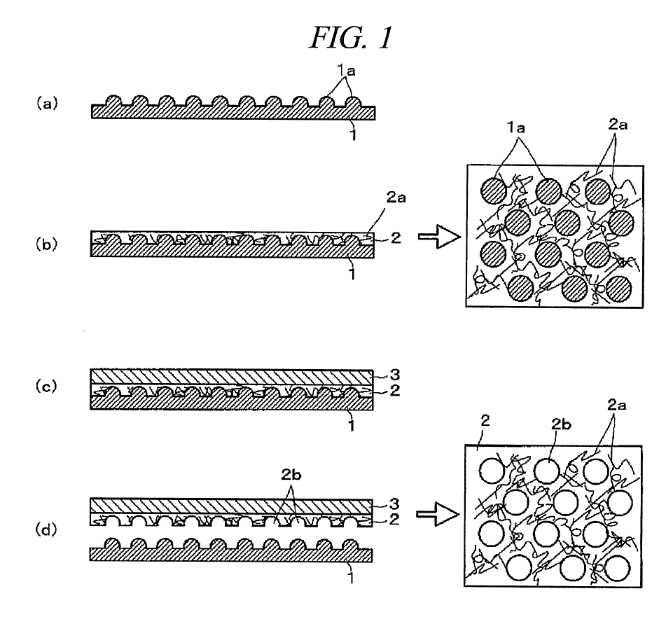

Hereinafter, embodiments of the present disclosure will be described with reference to the accompanying drawings. FIG. 1 is a diagram for describing a process sequence of a conductive film forming method in accordance with a first embodiment of the present disclosure. In the drawing, a reference numeral 1 denotes a mold having thereon prominences and depressions 1a.

By way of example, but not limited to, a silicon substrate, a quartz substrate or a Ni electroforming substrate may be used as the mold 1. The fine prominences and depressions 1a may be formed on the mold 1 by a LIGA process or a FIB (Focused Ion Beam) process. The prominences and depressions 1a of the mold 1 may have a function of appropriately dispersing fiber-shaped conductive substances 2a which will be described later. As a result, a thin film containing the fiber-shaped conductive substances 2a in a mesh shape may be formed. By way of example, the prominences and depressions 1a may include semispherical prominences each having a certain size (e.g., about 10 nm to about 10 μm), and the prominences are arranged at a regular interval (e.g., about 10 nm to about 10 μM).

In accordance with the first embodiment, as illustrated in FIG. 1(b), a material 2 containing fiber-shaped conductive substances 2a and having fluidity is coated on the prominences and depressions 1a of the mold 1. Here, the material 2 is coated such that at least the prominences and depressions 1a of the mold 1 are fully submerged therein. By way of example, but not limited to, a carbon nanotube (a single-walled CNT, a double-walled CNT, a multi-walled CNT, a rope-shaped CNT, etc.), a fine metallic fiber (Au, Ag, Pt, Pd, Cu, Ni, Co, Sn, Pb, Sn—Pb, etc.), a fiber-shaped material of gallium nitride (GaN), or a fiber-shaped material of zinc oxide (ZnO) may be used as the fiber-shaped conductive substance 2a. As a coating method of the material 2, various coating methods such as a die coating method, a gravure coating method and a roll coating method may be used.

By way of example, the material 2 may be made by dispersing the fiber-shaped conductive substances 2a in a solvent or by dispersing the fiber-shaped conductive substances 2a in a resin solution. By way of example, but not limited to, pure water, ethanol or methanol may be used as the solvent. Further, a thermosetting resin solution or a photo curable resin solution may be used as the resin solution. The thermosetting resin solution may include e.g., polyethylene terephthalate (PET), Polymethyl methacrylate (PMMA), polycarbonate (PC) and polylactic acid (PLA). The photo curable resin solution may include, e.g., acrylic monomer, acrylic oligomer, Polyester acrylate, polyurethane acrylate or epoxy acrylate.

Further, when necessary, a dispersing agent may be added in the material 2. If the solvent as mentioned above is used for the material 2, a surfactant having an amino group of tertiary amine may be used as the dispersing agent, for example. Although a dispersion temperature for dispersing the carbon nanotubes is not particularly limited, the dispersion temperature may be set to be, by way of example, about 10° C. to about 180° C., more desirably, may be set to be about 20° C. to about 40° C. If the dispersion temperature is too low, the carbon nanotubes may not be easily dispersed, whereas if the dispersion temperature is too high, the carbon nanotubes may be re-condensed.

As stated above, if the material 2 containing the fiber-shaped conductive substances 2a and having fluidity is coated on the prominences and depressions 1a of the mold 1, the fiber-shaped conductive substances 2a may be dispersed in a mesh shape around prominences of the prominences and depressions 1a of the mold 1, as depicted in the right side of FIG. 1(b).

Subsequently, a substrate 3 is placed to be in contact with the material 2 coated on the mold 1. The material 2 is disposed between the mold 1 and the substrate 3 adjacent to the mold 1. In this state, a process for reducing the fluidity of the material 2 is performed. Further, a transparent inorganic substrate such as a glass substrate or a quartz substrate, or a flexible transparent substrate such as plastic may be used as the substrate 3. The flexible transparent substrate may be made of, but not limited to, polyethylene terephthalate, polyethylene naphthalate, polyether sulfone, polycarbonate, polystyrene, polypropylene, polyester, polyimide, polyether ether ketone, polyetherimide, acrylic resin, olefin maleimide copolymer, norbornene-based resin, or the like. When the flexible transparent substrate is used as the substrate 3, the process can be performed while transferring a sheet-shaped material for the flexible transparent substrate between a roll and a roll, as will be described later.

The process for reducing the fluidity of the material 2 may be performed by a heating process when the material 2 made by dispersing the fiber-shaped conductive substances 2a in the solvent is used. Meanwhile, when the material 2 made by dispersing the fiber-shaped conductive substances 2a in the resin solution is used, the process for reducing the fluidity may be performed by a heating process if the thermosetting resin solution is used or may be performed by an ultraviolet ray irradiation process if the photo curable resin solution is used.

Subsequently, as illustrated in FIG. 1(d), the mold 1 is separated from the material 2. Accordingly, as shown in FIG. 1(d), a thin resin film containing the fiber-shaped conductive substances 2a disposed around recesses 2b of the hardened material 2 in a mesh shape or a mesh-shaped thin film of the fiber-shaped conductive substances 2a is formed. The recesses 2b are formed at positions corresponding to the prominences of the mold 1. Further, in this process of separating the mold 1 from the material 2, the mold 1 may be easily separated from the material 2 by, e.g., applying ultrasonic vibration.

In the process of separating the mold 1 from the material 2, the surface of the mold 1 may be previously coated with a certain material in order to be easily separated from the material 2. By way of non-limiting example, a fluorine resin may be coated on the surface of the mold 1. If the mold 1 is made of quartz, a water-repellency process may be performed on the surface of the mold 1 with a perfluoroalkyl-based silane coupling agent.

When the material 2 made by dispersing the fiber-shaped conductive substances 2a in the solvent is used, the thin film containing the fiber-shaped conductive substances 2a dispersed in a mesh shape but not containing the resin may be formed. Thus, when necessary, the resin solution may be coated and hardened to form a protection film. Meanwhile, when the material 2 made by dispersing the fiber-shaped conductive substances 2a in the resin solution is used, the recesses 2b are formed on the thin resin film containing the fiber-shaped conductive substances 2a in a mesh shape. Thus, when necessary, the resin solution may be coated and hardened so as to flatten the surface of the material 2.

In the above-stated first embodiment, the thin film in which the fiber-shaped conductive substances 2a are dispersed in a mesh shape is formed as the conductive film by using the mold 1 having thereon the prominences and depressions 1a. Accordingly, a process for mixing fine particulate materials with the material 2 or a process for removing the mixed particulate materials need not be additionally performed. Therefore, as compared to the conventional cases, time and cost for forming the conductive film can be reduced, and productivity thereof can be improved. Moreover, in accordance with the first embodiment, patterns of the regular prominences and depressions 1a of the mold 1 are transferred to the top surface of the conductive film. Further, the fiber-shaped conductive substances 2a are properly dispersed over the entire region of the conductive film. Accordingly, uniform conductivity can be achieved over the whole conductive film. Further, patterns of the regular prominences and depressions 1a are transferred to portions of the transparent conductive film where the fiber-shaped conductive substance 2a does not exist. Therefore, it may be possible to form the transparent conductive film having uniform light transmissivity over the entire region thereof.

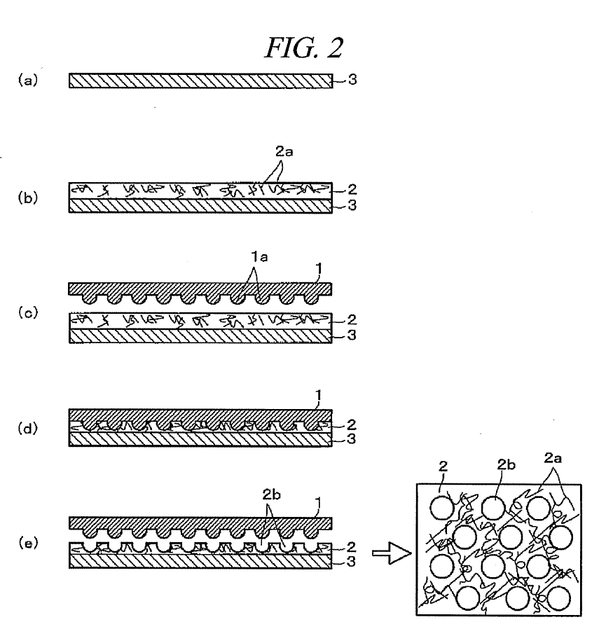

Now, a second embodiment of the present disclosure will be explained with reference to FIG. 2. In the second embodiment, as illustrated in FIG. 2(b), a material 2 containing fiber-shaped conductive substances 2a and having fluidity is coated on a substrate 3 shown in FIG. 2(a).

Then, as shown in FIGS. 2(c) and 2(d), a mold 1 having thereon prominences and depressions 1a is brought into contact with the material 2 coated on the substrate 3 while allowing the prominences and depressions 1a of the mold 1 to face the substrate 3. Thus, the material 2 is disposed between the mold 1 and the substrate 3 that are closely positioned to face each other. Here, the material 2 and the mold 1 are then brought into contact with each other such that at least the prominences and depressions 1a are fully submerged in the material 2. In this state, a process for reducing the fluidity of the material 2 is performed.

Subsequently, as illustrated in FIG. 2(e), the mold 1 is separated from the material 2. Accordingly, as shown in the right side of FIG. 2(e), a thin resin film containing fiber-shaped conductive substances 2a disposed around recesses 2b of the hardened material 2 in a mesh shape or a mesh-shaped thin film of the fiber-shaped conductive substance 2a may be formed. The recesses 2b are formed at positions corresponding to prominences of the mold 1.

As described above, the second embodiment is different from the first embodiment in that the material 2 is not coated on the mold 1 but coated on the substrate 3. Excepting this, the second embodiment is the same as the first embodiment. Thus, redundant description will be omitted. Further, the same effect that obtained in the first embodiment can also be achieved in the second embodiment.

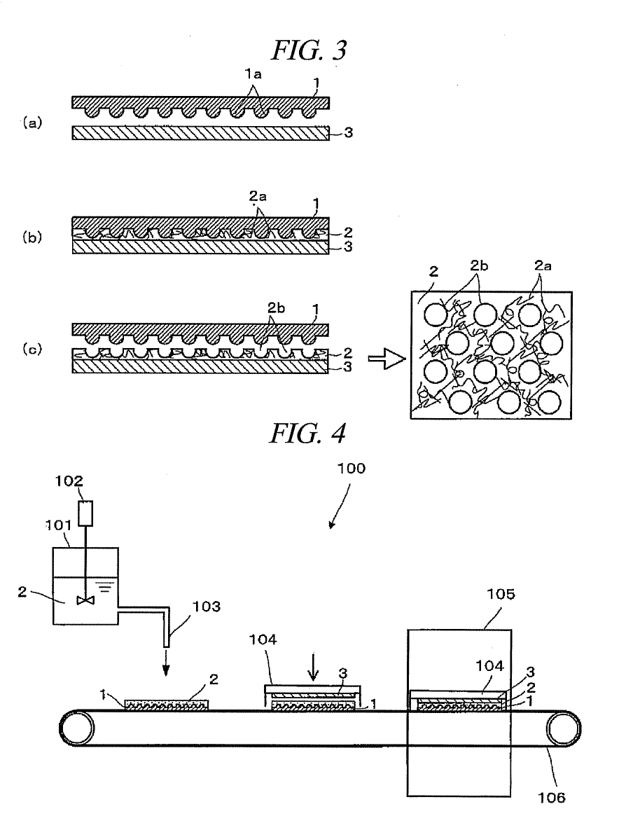

Now, a third embodiment of the present disclosure will be explained with reference to FIG. 3. In the third embodiment, as shown in FIG. 3(a), a mold 1 is placed to be adjacent to a substrate 3 while allowing the prominences and depressions 1a of the mold 1 to face the substrate 3.

Then, as shown in FIG. 3(b), a material 2 containing fiber-shaped conductive substances 2a and having fluidity is supplied into a space between the mold 1 and the substrate 3. Accordingly, the material 2 is disposed between the mold 1 and the substrate 3 that are closely positioned to face each other. Then, in this state, a process for reducing the fluidity of the material 2 is performed. By way of example, as a method for supplying the material 2 into the space between the mold 1 and the substrate 3, the material 2 may be supplied from lateral sides of the mold 1 and the substrate 3 or may be supplied from multiple through holes previously formed in the mold 1.

Thereafter, as shown in FIG. 3(c), the mold 1 is separated from the material 2. As a result, as shown in the right side of FIG. 3(c), a thin resin film containing fiber-shaped conductive substances 2a disposed around recesses 2b of the hardened material 2 in a mesh shape or a mesh-shaped thin film of the fiber-shaped conductive substances 2a is formed. The recesses 2b are formed at positions corresponding to prominences of the mold 1.

As described above, the third embodiment is different from the first embodiment in that the material 2 is not coated on the mold 1 but the material 2 is supplied into the space between the mold 1 and the substrate 3 closely placed to face each other. Excepting this, the third embodiment is the same as the first embodiment. Thus, redundant description will be omitted. Further, the same effect as obtained in the first embodiment can also be achieved in the third embodiment.

Now, an embodiment of a conductive film forming apparatus in accordance with the present disclosure will be discussed. As shown in FIG. 4, a conductive film forming apparatus 100 may include a vessel 101 that stores therein a material 2 containing a fiber-shaped conductive substance 2a and having fluidity. A mixing device 102 for mixing the material 2 is provided at the vessel 101. Further, the conductive film forming apparatus 100 may include a nozzle 103 communicating with the vessel 101. Further, the nozzle 103 is configured to coat the material 2 stored in the vessel 101 on a mold 1 having thereon prominences and depressions 1a or on a substrate 3 (In FIG. 4, the material 2 is shown to be coated on the mold 1).

Further, the conductive film forming apparatus 100 may include a substrate stage 104 serving as a device for holding the substrate 3 and placing the mold 1 to be adjacent to the substrate 3. Further, the conductive film forming apparatus 100 may include a hardening unit 105 configured to reduce the fluidity of the material 2 between the mold 1 and the substrate 3. The hardening unit 105 may include a heating device or an ultraviolet ray irradiation device. A reaction time and circumstances within the hardening unit 105 may be varied depending on the kind of a conductive film to be processed by the hardening unit 105.

Further, a transfer device 106 including, e.g., a belt conveyor is also provided within the conductive film forming apparatus 100. The transfer device 106 is configured to transfer the mold 1 and the substrate 3 from an arrangement position of the nozzle 103 into the hardening unit 105. In the above-described conductive film forming apparatus 100, as a conductive film, a thin film in which the fiber-shaped conductive substance 2a is dispersed in a mesh shape can be formed on the substrate 3 while carrying the mold 1 and the substrate 3 by the transfer device 106.

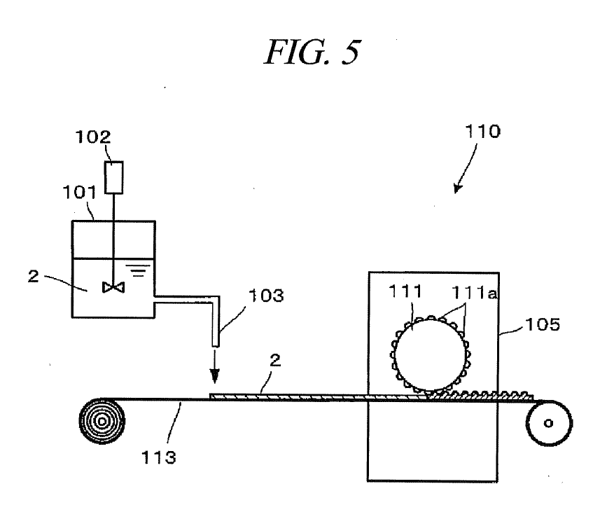

FIG. 5 illustrates a configuration of a conductive film forming apparatus 110 in accordance with another embodiment of the present disclosure. In FIG. 5, like parts corresponding to those of the conductive film forming apparatus 100 shown in FIG. 4 will be assigned like reference numerals, and redundant description thereof will be omitted.

In the conductive film forming apparatus 110 in accordance with the present embodiment, a flexible substrate 113 is used instead of the plate-shaped substrate 3. Specifically, the flexible substrate 113 of a roll shape is transferred by being wound by a roll opposite to the roll-shaped flexible substrate 113 with a certain distance therebetween. Furthermore, a roller-shaped mold 111 having thereon prominences and depressions 111a is provided instead of the plate-shaped mold 1. While the roller-shaped mold 111 is in contact with a material 2 coated on the flexible substrate 113, the material 2 between the roller-shaped mold 111 and the flexible substrate 113 is hardened by a hardening unit 105. A reaction time and circumstances within the hardening unit 105 are varied depending on the kind of a conductive film to be processed by the hardening unit 105 and depending on a rotation device of the roller-shaped mold 111.

By rotating the roller-shaped mold 111 while transferring the flexible substrate 113, a thin film as a conductive film in which the fiber-shaped conductive substance 2a is dispersed in a mesh shape can be formed on the flexible substrate 113. In accordance with the conductive film forming apparatus 110, the same effect as obtained in the above-described embodiment can also be achieved. Further, by using the flexible substrate 113, it is possible to form the conductive film consecutively.

Further, it shall be understood that the present disclosure may not be limited to the above-described embodiments and may be modified in various ways.

### INDUSTRIAL APPLICABILITY

A conductive film forming method, a conductive film forming apparatus and a conductive film in accordance with the present disclosure may be applicable to the manufacture of electronic devices having conductive films. Thus, the present disclosure may have wide range industrial applicability.

### EXPLANATION OF CODES

1: Mold
1a: Prominences and depressions
2: Material
2a: Fiber-shaped conductive substance
2b: Recess
3: Substrate

What is claimed is:

1. A conductive film forming method comprising:
disposing a material containing a fiber-shaped conductive substance and having fluidity between a substrate and a mold having thereon prominences and depressions;
reducing the fluidity of the material; and
separating the mold from the material.

2. A conductive film forming method comprising:
coating a material containing a fiber-shaped conductive substance and having fluidity on a mold having thereon prominences and depressions;
bringing a substrate into contact with the material coated on the mold to dispose the material between the substrate and the mold;
reducing the fluidity of the material; and
separating the mold from the material.

3. A conductive film forming method comprising:
coating a material containing a fiber-shaped conductive substance and having fluidity on a substrate;
providing the material between the substrate and a mold having thereon prominences and depressions by bringing the mold into contact with the material coated on the substrate;
reducing the fluidity of the material; and
separating the mold from the material.

4. A conductive film forming method comprising:
placing a mold having thereon prominences and depressions to be adjacent to a substrate while allowing the prominences and depressions to face the substrate;
providing a material containing a fiber-shaped conductive substance and having fluidity between the substrate and the mold by supplying the material into a space between the mold and substrate;
reducing the fluidity of the material; and
separating the mold from the material.

5. The conductive film forming method of claim 1, wherein the material is made by mixing the fiber-shaped conductive substance in a solvent.

6. The conductive film forming method of claim 5, wherein the reducing the fluidity of the material is performed by a heating process.

7. The conductive film forming method of claim 1, wherein the material is made by mixing the fiber-shaped conductive substance in a resin solution.

8. The conductive film forming method of claim 7, wherein the reducing the fluidity of the material is performed by a heating process.

9. The conductive film forming method of claim 7, wherein the reducing the fluidity of the material is performed by an ultraviolet ray irradiation process.

10. The conductive film forming method of claim 1, wherein the fiber-shaped conductive substance includes a carbon nanotube.

11. A conductive film forming apparatus for forming a conductive film on a substrate, the apparatus comprising:
a vessel that stores therein a material containing a fiber-shaped conductive substance and having fluidity, and that includes a device for mixing the material;
a mold having thereon prominences and depressions;
a nozzle, communicating with the vessel, for coating the material on either the mold or the substrate;
a device for placing the substrate to be adjacent to the mold; and
a hardening unit for reducing the fluidity of the material between the mold and the substrate.

12. The conductive film forming apparatus of claim 11, wherein the hardening unit is configured to heat the material.

13. The conductive film forming apparatus of claim 11, wherein the hardening unit is configured to irradiate an ultraviolet ray to the material.

14. A conductive film comprising:
a fiber-shaped conductive substance; and
a layer having prominences and depressions on a top surface thereof.

15. The conductive film of claim 14, wherein the fiber-shaped conductive substance includes a carbon nanotube.
